(19) United States
(12) Patent Application Publication
(10) Pub. No.: US 2010/0211433 A1
(43) Pub. Date: Aug. 19, 2010

(54) SYSTEM AND METHOD FOR SCORING GROUPS

(76) Inventor: Michael McKean, Rehoboth Beach, DE (US)

Correspondence Address: The Small Patent Law Group LLP, Suite 725, 225 S. Meramec, St. Louis, MO, 63105, US

(21) Appl. No.: 12/371,282

(22) Filed: Feb. 13, 2009

(51) Int. Cl. G06Q 10/00

(52) U.S. Cl. 705/10; 705/7

(57) ABSTRACT

A system and method for scoring groups is provided. The method includes accessing stored past meeting activity information for a group and determining a stored setting for each of a plurality of indicators. The method further includes calculating with the computing system a score for each of the plurality of indicators for the group based on the stored past meeting activity information and displaying the score for each of the plurality of indicators.

### BACKGROUND OF THE INVENTION

This invention relates generally to sales force automation systems, and more particularly, to systems and methods for scoring groups or organizations that hold events in venues having space for temporary use.

Sales Force Automation (SFA) systems provide electronic tools to help facilitate managing client and potential client information for use in automating sales and sales force management functions. SFA systems are typically information systems used sales management and may be combined with marketing information to provide a customer relationship management system.

SFA systems may include different components, for example, a contact management component that tracks business contacts that have been made with a particular customer, the purpose of the contact, any follow up that may be needed, other related information, etc. Other components that may form part of SFA systems include sales forecasting components, order or event management components and product knowledge components.

SFA systems are intended to create some type of competitive advantage, as well as provide a more efficient approach to client development, thereby resulting in improved productivity of sales personnel. However, known SFA systems can be difficult to use and can require substantial user input to generate a list of potential sales leads. Moreover, the list may be based on factors that are not up to date or accurate because of the constant maintenance, information updating and system upgrading required to ensure proper operation of the SFA system. Additionally, a user of the SFA system may have to make telephone calls based on a large list of potential leads without any sense of which of leads may be more likely to lead to a possible sale.

### BRIEF DESCRIPTION OF THE INVENTION

In accordance with an embodiment of the invention, a method, implemented at least in part by a computing system, is provided. The method includes accessing stored past meeting activity information for a group and determining a stored setting for each of a plurality of indicators. The method further includes calculating with the computing system a score for each of the plurality of indicators for the group based on the stored past meeting activity information and displaying the score for each of the plurality of indicators.

In accordance with another embodiment of the invention, a user interface for providing on a display a scoring for a group based on stored past meeting activity information includes a graphic associated with each of a plurality of indicators and an associated text corresponding to each of the plurality of indicators. The user interface further includes a value corresponding to a score for each of the plurality of indicators for the group based on the stored past meeting activity information.

In accordance with yet another embodiment of the invention, a computer program product for scoring groups is provided. The computer program product is embodied on one or more computer-readable storage media and includes computer-readable program code causing a computing device to perform the method of accessing stored past meeting activity information for a group and determining a stored setting for each of a plurality of indicators. The method also includes calculating with the computing system a score for each of the plurality of indicators for the group based on the stored past meeting activity information and displaying the score for each of the plurality of indicators.

In accordance with still another embodiment of the invention, a system for scoring groups is provided that includes a database storing past meeting activity information and a computer configured to access the stored past meeting activity information and calculate a score for each of the plurality of indicators for a group based on the stored past meeting activity information. The system further includes a display configured to display the score for each of the plurality of indicators.

### BRIEF DESCRIPTION OF THE DRAWINGS

FIG. 1 is a diagram illustrating a system in connection with which various embodiments of the invention may be implemented or operated.

FIG. 2 is a flowchart of a method for scoring groups or leads in accordance with various embodiments of the invention.

FIG. 3 is a partial screenshot of a user interface formed in accordance with various embodiments of the invention.

FIG. 4 is a screenshot of another user interface formed in accordance with various embodiments of the invention.

FIG. 5 is a screenshot of another user interface formed in accordance with various embodiments of the invention.

FIG. 6 is a chart illustrating calculation of an overall rating score and a star rating in accordance with various embodiments of the invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry or software components. Thus, for example, one or more of the functional blocks (e.g., processors or memories) may be implemented in a single piece of hardware (e.g., a general purpose signal processor or random access memory, hard disk, or the like) and in one or more different software components. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments of the invention provide a system and method that uses past information, for example, past meeting activity to score groups or organizations (or sales leads corresponding to a group or organization) that temporarily occupy space in a venue (e.g., rent a meeting room in a hotel). The scoring may be used to determine, for example, a likelihood that a group or organization will temporarily occupy a space in a venue in the future. Different indicators and weighting methods may be provided and modified based on user inputs. Additionally, while the various embodiments may be described in connection with using particular indicators or past meeting activity, different or additional indicators and past meeting activity may be used. In general, any type of past purchasing or meeting/event indicators may be used. Additionally, it should be noted that the temporary use of space refers to any use of space that is not permanent (i.e., property is not purchased), and may include, for example, space that is rented or leased for a few hours, a day, a week, a month, or even longer.

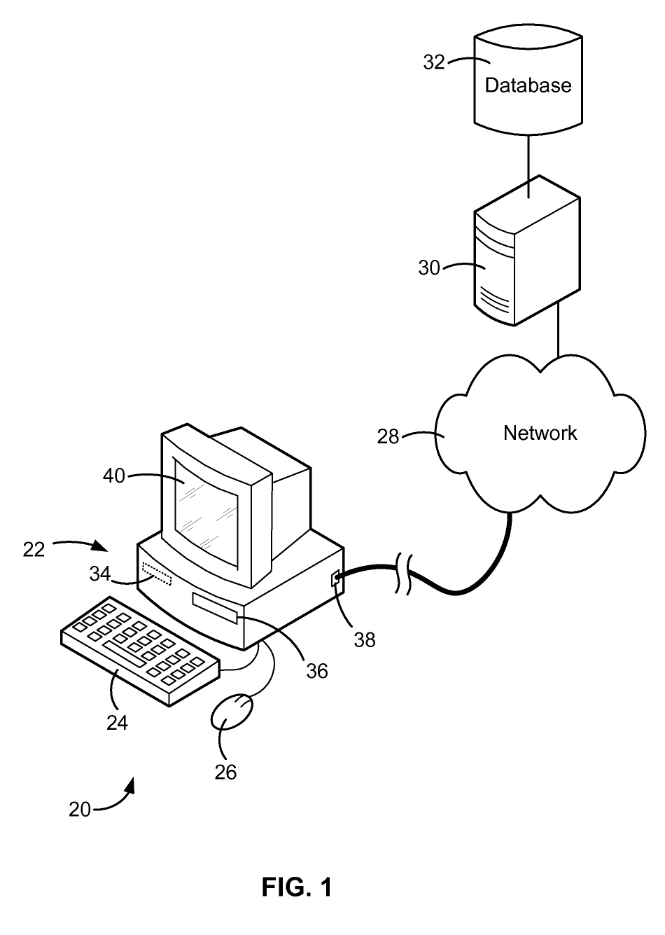

Embodiments of the invention enable a user to select, review and otherwise manipulate electronically stored sales data and related information using a system 20 as illustrated in FIG. 1. The system 20 allows a user to select different criteria or indicators for use in scoring groups or organizations based on past activity. For example, the system 20 may include a client-side device, such as a computer 22 that receives user inputs via one or more user interface selection devices, illustrated as a keyboard 24 and mouse 26 and provides scoring results, such as via a network 28 based on the predefined or user defined criteria or indicators. The system 20 may include a server 30 that is configured to receive group scoring or sales lead requests from a user accessing the network 28 with the computer 22. The server 30 receives the requests and processes the requests based on information relating to prior activity, for example, past group meeting activities in different venues or different locations within the same venue that are stored in a database 32 connected to the server 30. The received requests and results from the processing also may be stored in the database 32. The results may include a list of groups or sales leads each having a corresponding score.

It should be noted that the processing of the requests may be performed locally at the computer 22 that may include an internal storage device 34 (e.g., hard-disk drive) for storing the prior or past activity information and for storing instructions that cause a processor of the computer 22 to perform scoring operations of the various embodiments. The computer 22 also may include an external reading/writing device 36 (e.g., CD or DVD drive) for receiving a computer readable medium. A network interface 38 (e.g., local area network (LAN) connection) may be provided to allow connection to the network 28. Thus, the system 20 may provide a server and computer based interactive system that can be accessed locally, through an intranet, or through the World Wide Web or through one or more Internets via a graphical user interface as described in more detail herein. It also should be noted that one or more computers 20 located at the same or different location may be provided.

It further should be noted that when reference is made herein to a sales lead, this refers to any type of information relating to potential future sales activity. For example, a sales lead can be any indicator for future purchase or rent of goods or services, such as space within a venue.

The server 30 may be configured to score groups (or organizations) that meet in venues (e.g., hotels) having space that can be temporarily occupied, to develop, for example, sales leads for the venues. The scoring of the groups may be based on one or more indicators that may be categorized, with each venue defined by one or more indicators. The server 30 also may be configured to provide scaled and overall scores for each group and then display on a display 40 of the computer 22 scoring of the group or a plurality of groups, which may or may not be related. The scoring may be a scoring of leads for potential groups, for example, to occupy a meeting space in a hotel during a specific time period. The user is allowed to select an individual group to obtain additional information, for example, past purchasing indicators for the particular group. It should be noted that when reference is made herein to a group, this refers to any type of group, organization, entity, company, etc.

In various embodiments, the database 32 stores the prior or past activity information, such as past event and activity information corresponding to groups or organizations. For example, the database 32 may store for each group or organization specific information regarding a past event or meeting that the group or organization held at a particular venue, such as a hotel. The information may be acquired and stored in any manner. For example, the information may be acquired from customer surveys, field research, mystery shoppers, actual purchasing or meeting history information, such as from a contracted venue, etc. In general, the information is any type of information that has been acquired and stored relating to the past activity of the group or organization. The stored information includes, for example, the name of each group, and for each past activity, the name of the past activity, the location of the past activity (and associated information such as the type of the location, amenities of the location, etc.), the time and date of the past activity, the size of the space for the last activity, etc. In general, the information includes information regarding the circumstances and characteristics of the venue for the past activity.

The stored information regarding the groups in some embodiments includes a unique identifier for each group. For example, as described herein, companies having more than one corporate center may have separate listings for each corporate center. In addition to a unique identifier, the groups past meeting activity is tracked and recorded as described herein. Information relating to the meeting activity is stored according to the indicators (or other groupings), for example, price (or class) segmentation, size (or size compatibility), brand (or brand affinity), time of year (or time of year propensity), time of week (or time of week propensity), amenity (or amenity affinity), and several geographic indicators are described herein. Each indicator includes a plurality categories or defined sub-indicators. The categories in some embodiments are predetermined, but may be changed. Accordingly, when a group uses a venue to hold a meeting or event, the categories of the indicators for that meeting are tracked and stored. Categories are typically specific (and related) to the indicator under which that category is grouped.

Various embodiments of the invention score groups or leads based on the plurality of indicators, with each indicator using the plurality of predefined or predetermined categories. For example, in some embodiments that may be useful in scoring groups that have occupied hotel space, the following indicators may be selected by a user (the indicators each including a plurality of categories):

1. Geographic Region (e.g., East North Central, Middle Atlantic, Mountain, Pacific, etc.)

2. Geographic Market (e.g., Alabama North, California Central Coast, Denver, CO, etc.)

3. Geographic Tract (e.g., Research Triangle/Airport, Atlanta Downtown, Austin US 290/I-35 Area, etc.)

4. Venue Type (e.g., Airport, Interstate, Resort, Suburban, Urban, etc.)

5. Time of Year Propensity (e.g., Holiday, Spring, Fall, January, February, etc.)

6. Price Segmentation (e.g., Budget, Economy, Luxury, Midprice, Upscale, etc.)

7. Size Compatibility (e.g., less than 1000 square feet (sq. ft.), 2,000-3,000 sq. ft, greater than 25,000 sq, ft, etc.)

8. Time of Week Propensity (e.g., Weekday, Weekend, Overlap, etc.)

9. Brand Affinity (e.g., hotel name, chain of hotels name, etc.)

10. Class Segmentation (e.g., Economy, Luxury, Midscale, Upscale, etc.)

11. Amenity Affinity (e.g., Restaurant, Bar, Casino, Golf, Tennis, Beach, Business Center, Gym, Pets Allowed, etc.)

It should be noted that the indicators are not limited to the indicators described above, but may include any type of indicator. For example, the indicators may be specific to a particular industry and are not limited to the hotel industry. Additionally, the categories for each indicator may be mutually exclusive or may not be mutually exclusive and overlap. It also should be noted that the past meeting activity information may be stored, for example, in the database 32 such that the information is accessible based on the indicators.

The categories for each indicator may be determined or defined by travel industry standards or some other means. The categories generally include every geographic region, market, tract, and hotel type in the geographic area (e.g., the United States (a region thereof) or the world). Additionally, the non-geographic region categories may be divided into logical related categories that include, for example, any time of year, any time of week, any size, any price, any brand, any class, and any amenity as desired or as needed to track and store the meeting activity of the groups.

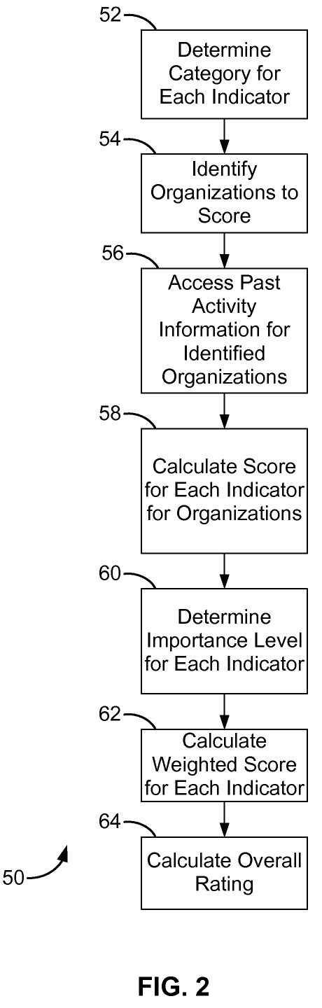

The various embodiments use the indicators and past activity for groups to generate a score for each of the groups, which may be used to develop sales leads (e.g., to determine the likelihood that the group will rent a space in a venue in the future). In particular, a method 50 as shown in FIG. 2 is provided for scoring groups, especially, scoring or rating groups (e.g., organizations or companies) based on the characteristics of the venues (defined by the indicators) of past activities, including events or meetings for the groups. The method 50 may be performed, for example, by the system 20 (shown in FIG. 1) to score, rate or otherwise rank groups, particularly to develop sales leads, for example, leads for venues having available space to be occupied for a certain time period (e.g., a one day meeting). The method 50 includes determining at 52 a category for each indicator. In particular, for each indicator, one category is selected from a list of categories. For example, a user may select from a pop-up menu or drag-down list one predefined category for each of the indicators. The selectable categories may appear, for example, responsive to a right-click of a user interface selection member (e.g., a mouse or touchpad) while hovering over a particular selection element of a user interface.

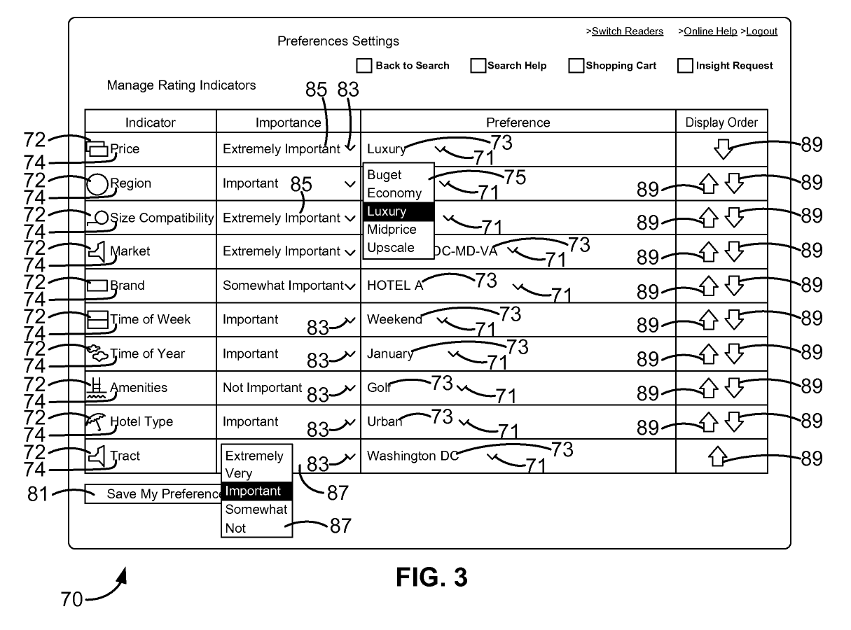

In some embodiments, a user interface 70 is provided, a portion of which is shown in FIG. 3, that includes a graphic 72 and associated text 74 corresponding to each of the plurality of definable indicators (organized in a single column of the user interface 70). The user interface provides for defining preference settings for each of the indicators. It should be noted that the user interfaces described herein and the methods described in connection therewith may be utilized with or operated using the system 20 (shown in FIG. 1), for example, operating on the computer 22. The user interface 70 also includes a selection element 71 associated with each of the displayed indicators that allows a user to select or change the definition or category for each of the indicators, for example, by changing a preference field 73. In particular, while hovering over the selection element 71, and for example, left-clicking on a mouse, a list 75 of predefined categories is displayed and selectable by a user. For example, if the user clicks on the selection element 71 corresponding to the Price indicator, which is shown as displaying a “Luxury” category, a list 78 of different categories is displayed. A user is then able to select a different category to define the Price indicator, for example, based on a particular hotel of interest that has free space for a meeting (e.g., operator wants to rent space in a hotel). Additionally, a user may remove the indicator from the scoring process, for example, by selecting a “N/A” category (not shown), which removes the indicator from the calculation of score for the group(s) of interest. It should be noted that the categories for each of the indicators may be changed at any time and saved using a selection element 81, for example, by hovering over the selection element 81, and left-clicking on a mouse. Accordingly, a user is able to pick (e.g., pre-define) for each indicator a setting defined by a category, such as in the brand, region, price segmentation, etc. of the business operated by the user (e.g., hotel operator).

The user interface 70 also includes a plurality of selection elements 83 associated with each of the plurality of definable indicators that allows a user to select or change an importance level for each of the indicators, for example, by changing a preference field 85. In particular, while hovering over the selection element 83, and for example, left-clicking on a mouse, a list 87 of predefined importance levels is displayed and selectable by a user. For example, if the user clicks on the selection element 83 corresponding to the Tract indicator, which is shown as displaying a “Important” importance level, a list 87 of different importance levels is displayed. A user is then able to select a different importance level for the Tract indicator, for example, based on a particular hotel of interest that has free space for a meeting (e.g., operator wants to rent space in a hotel). The selectable importance levels may include Extremely Important, Very Important, Important, Somewhat Important and Not Important. Each of the importance levels corresponds to a different weighting for scoring the indicator as described in more detail herein. It should be noted that the importance level for each of the indicators may be changed at any time and saved using the selection element 81, for example, by hovering over the selection element 81, and left-clicking on a mouse. Accordingly, a user is able to pick (e.g., pre-define) for each indicator an importance level).

It further should be noted that the defined categories (preference) and importance levels for each of the indicators is used for all scoring as described herein unless otherwise changed. In particular, for any group(s) that are selected, the scoring is based on the pre-defined category (preference) and importance level for each indicator.

The user interface 70 also may include a plurality of selection elements 89 (illustrated as one or more arrows) associated with each of the plurality of definable indicators that allows a user to change the display order of the indicators. In particular, while hovering over the selection element 89, and for example, left-clicking on a mouse, the indicator is moved up or down in the list of indicators, such as, based on whether an up arrow or down arrow is selected. The changed order of indicators may be saved using the selection element 81, for example, by hovering over the selection element 81, and left-clicking on a mouse.

Referring again to FIG. 2, after each of the indicators are defined, groups of interest are identified at 54. The groups may be manually identified, for example, by a user selecting from a list or map of different groups or automatically identified, for example, within a predetermined distance of a geographic location of interest (e.g., location of a hotel of interest). For example, one or more groups or organizations (e.g., companies, non-profit organizations, etc.) are identified for scoring according to the various embodiments of the invention. As an example, a computer accessible list of groups that have previously held at least one meeting in a venue of interest is generated.

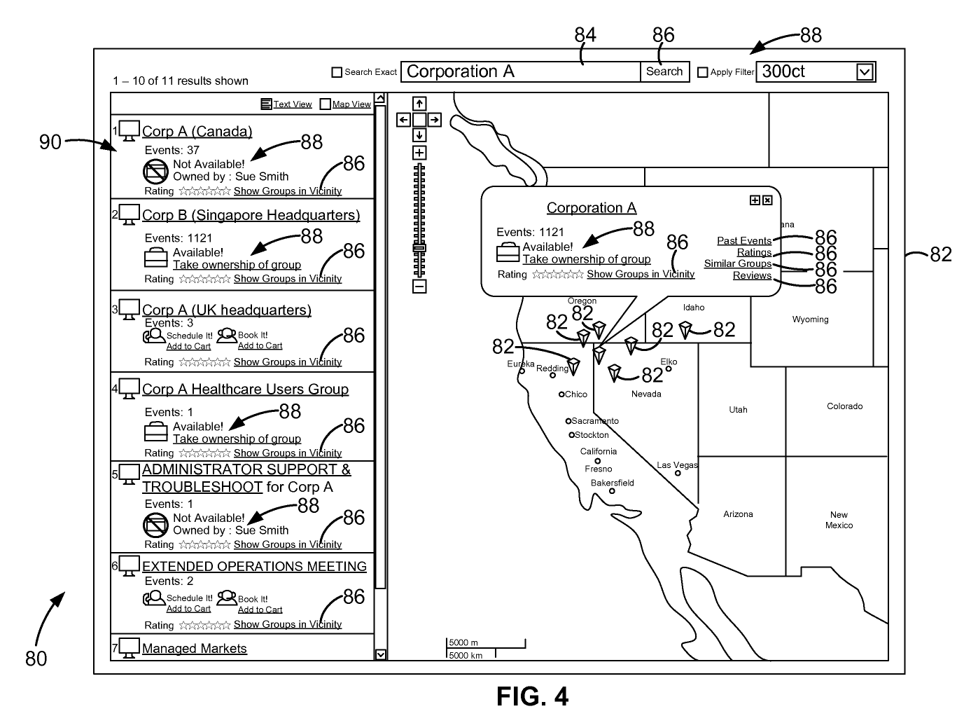

As another example, a map showing the region or area surrounding a location of interest (e.g., hotel operated by a user), may be displayed as part of a user interface 80 as shown in FIG. 4. The user interface may include an interactive map 82 allowing a user to select one or more groups identified by graphics 82. The graphics 82 may be displayed based on search criteria entered within a search field 84, with the search initiated by a selection element 86. Additionally, a filter field 88 may be provided to limit the number of results from the search.

In operation, while hovering over one of the graphics 82, and for example, right-clicking on a mouse, information about the group is displayed, such as the name of the group (and optionally the address for the group) and the number of past events held by that group. Additional information regarding the group may be accessed using one of a plurality of selection elements 86, which may include, for example, specific past event information (e.g., time, location, etc.), rating information, similar group information, reviews and other groups in the geographic vicinity of the selected group.

The user interface 80 also may indicate with respect to the group whether the group is available, for example, not a potential sales lead for another person and a user may change the status of the availability of the group using a selection element 88. It should be noted that the graphics 82 may be color coded to indicate the availability of the group corresponding to each graphic 82 (e.g., green for currently owned, red for co-owned and white for no ownership). Additionally, the user interface 80 may include a display list 90 showing other groups related to the selected group, which also displays similar information.

It should be noted that when used herein, a “group” refers to any group, company, corporation, club, individual, family, syndicate, operation, or entity that has ever held a meeting inside or outside of the group's own facilities. It also should be noted that when used herein, a “venue having available space” refers to any facility that has physical space that is available for hire, rent, or use by an organization. A venue having available space is typically actively seeking to fill any and all open spaces available in the venue. Although the venues described herein are hotels or convention centers, the venues may be, but are not limited to resorts, motels, theatres, movie theaters, malls, clubs, halls, ballrooms, museums, restaurants, warehouses, hangers, private homes, public and private beaches, public and private parks, public and private golf courses, arenas, stadiums, day spas, public and private pools, military bases, marinas, casinos reservations amusement parks, fair grounds, camp grounds, ski resorts, yachts, cruise ships, sailing boats, fishing boats, party buses, limousines, and large or small charter airplanes.

Referring again to FIG. 2, after the groups are identified at 54, past activity information for the identified groups is accessed at 56. For example, past activity information is accessed from a database, which includes information for each past activity for the identified group(s). The past activity information includes stored information for each activity (e.g., past meeting activity information) corresponding to each of the indicators. As described herein, the information may include for each event, the category in each indicator corresponding to that event (e.g., the price, size, time of week, etc. of the event).

For example, the information may include that Corporation A used venue B on December 25^{th} (Christmas Day), with the categories of Winter, December, and Holiday all be tracked and recorded within the Time of Year indicator, which information is not mutually exclusive to a particular indicator. As another example, the information may include that Corporation A used 5000 sq. ft. in an airport type economy hotel, which information is mutually exclusive to particular indicators.

It should be noted that in various embodiments, the venues (e.g., hotels) are associated with at least one category in each indicator. These category indicators may be changed, but often may remain unchanged unless, for example, the venue undergoes remodeling or expansion (or has added or removed amenities). Accordingly, a small, airport adjacent an economy hotel in Los Angeles with a business center and outdoor pool, would typically associate with the following categories for each indicator: Pacific (Region); Los Angeles (Market); LAX/Inglewood (Tract); Airport (Hotel Type); Economy (Price Segmentation); Economy Class (Class Segmentation); Business Center and Outdoor Pool (Amenity); EcoEcono (brand); and less than 2,000 sq. ft. (Size).

Using the accessed past activity information, a score is calculated for each indicator corresponding to each of the identified groups at 58. In particular, for each group a score is calculated for each of the indicators, which uses the stored past activity information for each group. The indicator score is calculated based on a raw indicator score and a total number of events (e.g., meetings) that the groups have held in one or more venues. The raw indicator score is generally calculated using the number of times the organization held an event that corresponded to a category for each of indicators. As described herein, the indicators are often non-mutually exclusive, such past meeting information corresponds to a raw indicator score in more than one category for any particular indicator. Accordingly, the total number of events is determined by summing all the past meetings/events that the group has had in any venue (e.g., all events stored in the database and acquired from a reader board service). The indicator score in some embodiments equals the raw indicator score (the number of events that correspond to the category of interest for the indicator) divided by the total number of events. The indicator score may be converted to a percentage indicator score by multiplying the score by 100.

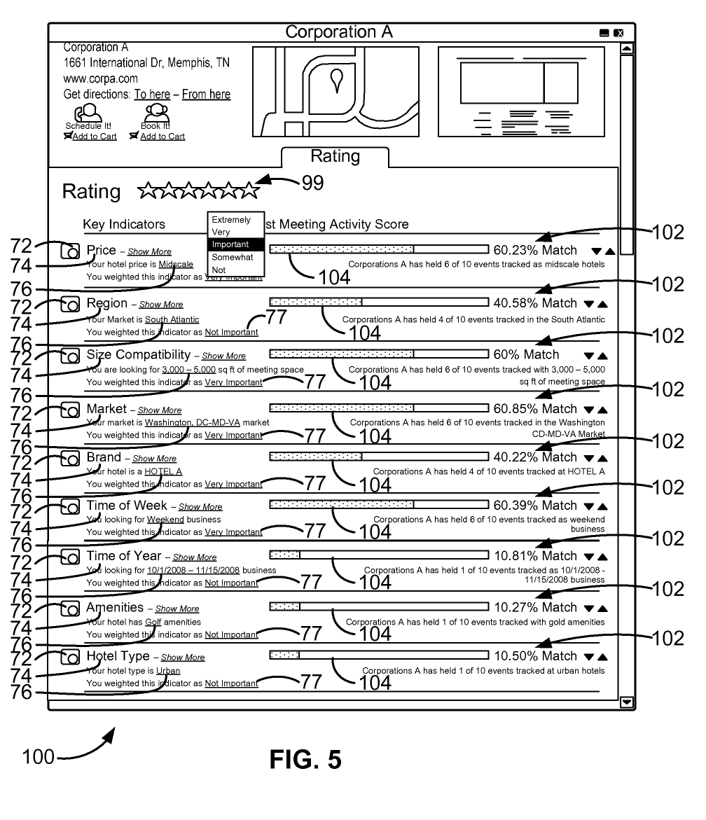

In various embodiments, the percentage indicator score is expressed as an integer value and two decimal places, for example, 72.34%. In other embodiments, the percentage indicator score is rounded to the nearest integer value, for example, 72%. In still other embodiments, the percentage scores may be rounded to the nearest 10 percent level to create a scale of 10 different percentage scores. For example, a plurality of percentage groups may be created, such as 10%, 20%, 30% . . . 100%. Thus, as shown in FIG. 5, an interface 100 may be provided showing the scoring results for each group. For example, a percentage score value 102 (e.g., 60.85% Match) is displayed in combination with each of the indicators identified by the text 74. A graphic indicator 104, for example, a color coded bar may be provided to indicate the relative percentage score value for each of the indicators. Additionally, the user interface 100 displays underlying scoring information 106 for each of the indicators that identifies, for example, the total number of tracked events/meetings for the organization and the total number that fall into the selected category for each indicator (e.g., 6 out of 10 events match the category). The category associated with each indicator may be changed using selection elements 76. The change affects only the scoring for the currently displayed group or organization and is not stored as a preference setting. In particular, while hovering over the selection element 76 (which is identified in the user interface 100 by underlined text), and for example, right-clicking on a mouse, a list (not shown, but similar to the list 75 shown in FIG. 3) of predefined categories (preferences) is displayed and selectable by a user. A user is then able to select a different category (preference) for a particular indicator. Thus, a change in one or more categories (preferences) corresponding to one or more indicators only changes the scoring for the currently displayed group or organization and does not change scoring for other groups or for the currently displayed group if scored again in the future. The category (preference) change using the selection element 76 is only a temporary change in the category (preference). A permanent change to the category (preference) is accomplished with the user interface 70 (shown in FIG. 3).

It should be noted that the calculated scores are stored, for example, in a database or in a memory of a computer, which may include lists of groups, the of raw indicator scores, the scaled indicator scores, and the percentage indicator scores. It also should be noted, as the groups continue to have additional events/meetings that are tracked, the system recalculates and updates all of the scores (and if necessary generates new scores).

The method 50 also optionally may generate an overall rating for the group. In particular, at 60, an importance level for each indicator is determined. In particular, a user may specify an importance level for each indicator. For example, with the user interface 70 shown in FIG. 3 or the user interface 100 shown in FIG. 5, selection elements 77 associated with each of the displayed indicators allows a user to select or change an importance level for each of the indicators. The change affects only the scoring for the currently displayed group or organization and is not stored as a preference setting. In particular, while hovering over the selection element 77 (which is identified in the user interface 100 by underlined text), and for example, right-clicking on a mouse, a list 78 of predefined importance levels is displayed and selectable by a user. For example, if the user clicks on the “Very Important” selection element 77 corresponding to the Price indicator, a list 79 of different importance levels are displayed. In various embodiments, the user is able to select from the following importance levels: Not Important, Somewhat Important, Important, Very Important and Extremely Important. A user is then able to select a different importance level corresponding to the Price indicator, for example, based on a particular hotel of interest that has free space for a meeting. Thus, a change in one or more importance levels corresponding to one or more indicators only changes the scoring for the currently displayed group or organization and does not change scoring for other groups or for the currently displayed group if scored again in the future. The importance level change using the selection element 77 is only a temporary change in the importance level. A permanent change to the importance level is accomplished with the user interface 70 (shown in FIG. 3).

Each importance rating may correspond to a different weighting value, which may be predetermined or predefined. The weighting value can be selected or changed as desired or needed. Additionally, the difference in weighting values between each of the importance levels may be the same (e.g., 0.5 difference between each importance level) or may be different. For example, as the importance level becomes higher or lower, the difference between weighting values for each importance level may become greater or smaller, or vice versa. In some embodiments, the importance levels have the following weighting values:

Not Important=0

Somewhat Important=0.5

Important=1

Very Important=1.5

Extremely Important=2

After a determination of the importance level for each indicator is determined at 60, for example, based on a user input or selection, a weighted score for each indicator is calculated from the raw indicator score or percentage indicator score at 62. In various embodiments, the score (whether raw or percentage) is multiplied by the weighting value corresponding to the importance level assigned to each indicator. Thus, if ten indicators are used, each having a corresponding importance level and calculated score, ten individual weighted indicator scores for the ten indicators are calculated. Accordingly, the weighting allows a user to indicate, for example, that one indicator is more important than one or more other indicators in relative terms. If the importance level for all of the indicators is set the same, then the weighting for all the indicators is the same, effectively resulting in no weighting for any of the indicators.

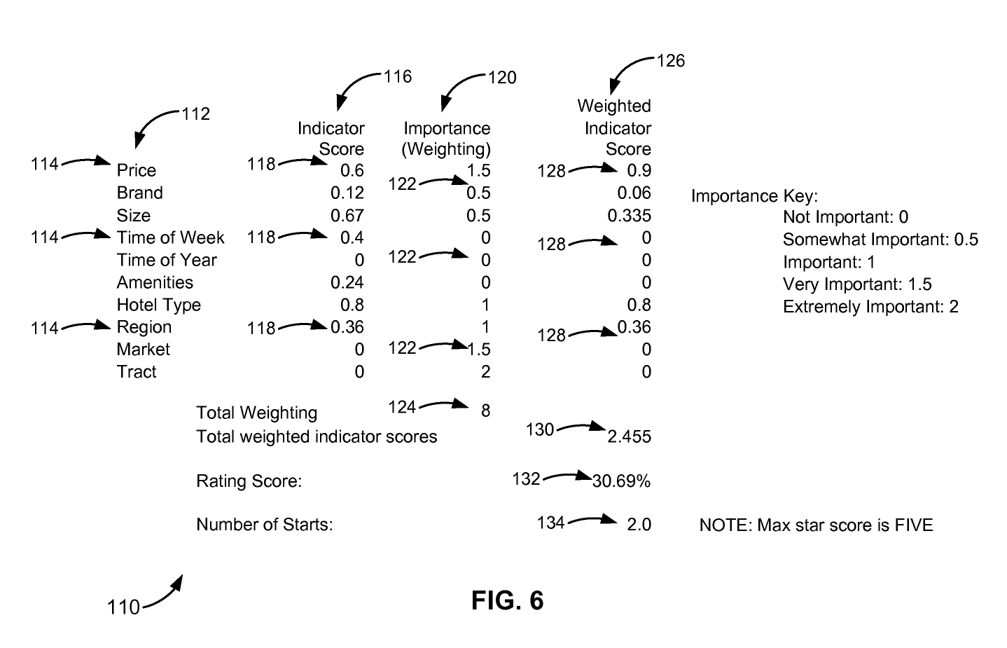

Accordingly, calculations of weighted indicator scores may be performed as shown in the exemplary chart 110 of FIG. 6, which represents calculations performed by a processing machine of the various embodiments, for example, the computer 22 or server 30 (shown in FIG. 1). As illustrated, a first column 112 identifies the indicators, for example, by indicator names 114. It should be noted that the indicator names 114 may correspond to the text 74 in the user interfaces 70 and 100 (shown in FIGS. 3 and 5). A second column 116 includes a corresponding raw indicator score 118 calculated for each of the indicators in the first column 112 as described in more detail herein. A third column 120 includes a weighting value 122 for each of the indicators. A total weighting value 124 also may be provided, which is the sum of all the weighting values in the third column 120. A fourth column 126 includes a weighted indicator score 128 for each of the indicators calculated by multiplying in each row the indicator score 118 by the importance weighting value 122. For example, for the Price indicator, the weighted indicator score is calculated as follows:

0.6×1.5=0.9

A total weighted indicator score 130 is calculated by summing each of the individual weighted indicator scores 128.

Referring again to the method 50 of FIG. 2, an overall rating is the optionally calculated at 64, which may include calculating an overall rating score 132 as shown in FIG. 6 and a star rating 134 indicating a number of stars for the group. In particular, the various embodiments calculate the overall rating score by dividing the total weighted indicator score 130 by the total weighting value 124. Accordingly, and continuing with the example illustrated in FIG. 6, the total rating score 132 is calculated as follows:

2.455/8=0.306875 (rounded to 0.3069)

The overall rating score 132 may be expressed as a percentage value, for example, by multiplying the result by 100. Thus, the overall rating score 132 in this example is 30.69%. The overall rating score 132 in some embodiments is not displayed to the user. However, the overall rating score 132 may be displayed as part of, for example, the user interface 100 (shown in FIG. 5).

Additionally, a star rating 134 indicating a number of stars also may be calculated. The star rating 134 (also referred to as a star score or star scale) is calculated by dividing the overall rating score 132 by 2. According, in this example, the star rating 134 is calculated as follows:

0.3069/2=0.15345

In the various embodiments, the star rating 134 is expressed as a value between 1 and 5 with 0.5 increments. Accordingly, the star rating 134 is multiplied by 10, resulting in this example, in a star rating of 1.5345, which is rounded up to the nearest 0.5 increment (corresponding no the nearest half star), namely 2.0. Thus, the star rating 134 based on the weighted indicator scores in this example, is 2.0. The star rating 134 may be displayed as a star rating graphic 99 as part of the user interface 100 shown in FIG. 5. It should be noted that the star rating graphic 99 displayed in FIG. 5 corresponds to a different set of indicator scores as shown therein, and accordingly the value of the star rating is different, resulting in a different number of stars for the star rating graphic 99, namely four stars instead of two stars.

It should be noted that the calculation of the overall rating score 132 and the star rating 134 may be modified as desired or needed. For example, additional multiplying factors may be included or the overall rating score 132 may be divided by a different integer or fractional number. Additionally, in some embodiments, the star rating 134 is limited to a maximum value of 5.0. However, the maximum value of the star rating 134 may be higher or lower, for example, four stars or six stars. Additionally, the graphic 99 corresponding to the star rating 134 may be changed or modified. For example, the graphic 99 may include a plurality of diamonds instead of stars.

It should be noted that other user interfaces and components are contemplated by the various embodiments. For example, the interactive system embodying the methods of various embodiments of the present invention may include different user interfaces having different interfaces for displaying the scoring.

Thus, various embodiments of the invention provide a method and system that uses past group activity, for example, past group meeting activity to score potential future activity, such as to score groups or sales leads. The indicators and scoring may be provided in any manner and in connection with one or more user interfaces. Accordingly, for example, past purchasing indicators may be used to predict future purchasing behavior.

It should be noted that the various embodiments or components, for example, the computer implemented or computer aided components or the systems described herein may be implemented as part of one or more computer systems, which may be separate from or integrated with other systems, for example, via a network. The computer system may generally include a computer, an input device, a display unit and an interface, for example, for accessing the Internet. The computer may include a microprocessor. The microprocessor may be connected to a communication bus. The computer may also include a memory. The memory may include Random Access Memory (RAM) and Read Only Memory (ROM). The computer system further may include a storage device, which may be a hard disk drive or a removable storage drive such as a floppy disk drive, optical disk drive, and the like. The storage device may also be other similar means for loading computer programs or other instructions into the computer system.

As used herein, the term “computer” may include any processor-based or microprocessor-based system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer system executes a set of instructions that are stored in one or more storage elements, in order to process input data. The storage elements may also store data or other information as desired or needed. The storage element may be in the form of an information source or a physical memory element within the processing machine.

The set of instructions may include various commands that instruct the computer as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. For example, the ordering of steps recited in a method need not be performed in a particular order unless explicitly stated or implicitly required (e.g., one step requires the results or a product of a previous step to be available). While the dimensions and types of materials described herein are intended to define the parameters of the invention, they are by no means limiting and are exemplary embodiments. Many other embodiments will be apparent to those of skill in the art upon reviewing and understanding the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method, implemented at least in part by a computing system, the method comprising:
accessing stored past meeting activity information for a group;
determining a stored setting for each of a plurality of indicators;
calculating with the computing system a score for each of the plurality of indicators for the group based on the stored past meeting activity information; and
displaying the score for each of the plurality of indicators.

2. A method in accordance with claim 1 wherein calculating the score comprises using a weighting value based on an importance level for each of the indicators.

3. A method in accordance with claim 2 wherein the importance level comprises a relative importance level.

4. A method in accordance with claim 1 wherein calculating the score comprises, for each of the indicators, summing all past meeting activity information and dividing by a total number of past meeting activities to determine a raw indicator score.

5. A method in accordance with claim 4 further comprising converting the raw indictor score to a percentage value.

6. A method in accordance with claim 4 wherein calculating the score further comprises multiplying the raw score for each of the indicators by a weighting value corresponding to an importance level to determine a weighted score.

7. A method in accordance with claim 6 further comprising defining the weighting value for each importance level according to:
Not Important=0
Somewhat Important=0.5
Important=1
Very Important=1.5
Extremely Important=2

8. A method in accordance with claim 6 wherein calculating the score further comprises summing the weighted scores and dividing a sum of the weighting values for the indicators by the sum of the weighted scores to determine an overall score.

9. A method in accordance with claim 8 further comprising dividing the overall score by two to generate a star score.

10. A method in accordance with claim 9 further comprising displaying a star rating graphic corresponding to the star score.

11. A method in accordance with claim 1 further comprising displaying a graphic indicator corresponding to each displayed score.

12. A method in accordance with claim 1 further comprising receiving a user input changing the stored setting for at least one of the indicators.

13. A method in accordance with claim 1 wherein calculating the score comprises using a weighting value based on an importance level for each of the indicators and further comprising receiving a user input changing the importance level for at least one of the indicators.

14. A method in accordance with claim 1 wherein the past activity information comprises past meeting activity information relating to renting a space in a venue.

15. A method in accordance with claim 1 wherein the group comprises one of an association, a corporation, a non-profit group, a government entity, or a social organization.

16. A method in accordance with claim 1 wherein the plurality of indicators comprise at least one of a price indicator, a region indicator, a size compatibility indicator, a market indicator, a brand indicator, a time of week indicator, a time of year indicator, an amenities indicator and a venue type indicator.

17. A method in accordance with claim 1 wherein the plurality of indicators comprise a price indicator, a region indicator, a size compatibility indicator, a market indicator, a brand indicator, a time of week indicator, a time of year indicator, an amenities indicator and a hotel type indicator.

18. A method in accordance with claim 1 wherein the past meeting activity information is stored in a database and corresponds to acquired actual past meeting activity information that is accessed by the computing system.

19. A method in accordance with claim 1 wherein calculating the score comprises determining a likelihood that a group will rent at a future time a space in a venue.

20. A user interface for providing on a display a scoring for a group based on stored past meeting activity information, the user interface comprising:
a graphic associated with each of a plurality of indicators;
an associated text corresponding to each of the plurality of indicators; and
a value corresponding to a score for each of the plurality of indicators for the group based on the stored past meeting activity information.

21. A user interface in accordance with claim 20 further comprising a plurality of selection elements for changing a preference for each of the plurality of indicators.

22. A user interface in accordance with claim 20 further comprising a plurality of selection elements for changing an importance level for each of the plurality of indicators.

23. A user interface in accordance with claim 20 further comprising a star rating graphic corresponding to a weighted sum of the values.

24. A user interface in accordance with claim 20 further comprising a graphic indicator corresponding to each of the values.

25. A computer program product for scoring groups, the computer program product embodied on one or more computer-readable storage media and comprising computer-readable program code causing a computing device to perform the method of:
accessing stored past meeting activity information for a group;
determining a stored setting for each of a plurality of indicators;
calculating with the computing system a score for each of the plurality of indicators for the group based on the stored past meeting activity information; and
displaying the score for each of the plurality of indicators.

26. A system for scoring groups comprising:
a database storing past meeting activity information;
a computer configured to access the stored past meeting activity information and calculate a score for each of the plurality of indicators for a group based on the stored past meeting activity information; and
a display configured to display the score for each of the plurality of indicators.

27. A system in accordance with claim 26 wherein the computer is configured to calculate a weighted score for each of the plurality of indicators and an overall weighted score for the group based on a pre-defined weighting value corresponding to an importance level for each of the indicators.
